(19) United States
(12) Patent Application Publication
(10) Pub. No.: US 2023/0252005 A1
(43) Pub. Date: Aug. 10, 2023

(54) Method And Apparatus For Managing Meta Information In Schema Level

(71) Applicant: TmaxTibero Co., Ltd., Gyeonggi-do (KR)

(72) Inventors: Kunwoo PARK, Seoul (KR); Taeseop KIM, Gyeonggi-do (KR); Kwangwon PARK, Gyeonggi-do (KR); Hyosik YUN, Gyeonggi-do (KR); Joohyun LEE, Gyeonggi-do (KR); Sangyoung PARK, Seoul (KR)

(73) Assignee: TmaxTibero Co., Ltd., Gyeonggi-do (KR)

(21) Appl. No.: 17/696,502

(22) Filed: Mar. 16, 2022

(30) Foreign Application Priority Data
Feb. 4, 2022 (KR) 10-2022-0014626

(51) Int. Cl. G06F 16/21; G06F 16/25; G06F 16/22

(52) U.S. Cl. CPC G06F 16/211; G06F 16/256; G06F 16/2282

(57) ABSTRACT

A method of configuring a virtual database performed by a computing device is disclosed. The method may include: generating a plurality of schemas by mapping a meta table space including meta information for a schema to the schema; and generating a plurality of virtual databases based on at least one schema among the plurality of generated schemas. Herein, one of the plurality of schemas is mapped with one meta table space.

### CROSS-REFERENCE TO RELATED APPLICATIONS

This application claims priority to and the benefit of Korean Patent Application No. 10-2022-0014626 filed in the Korean Intellectual Property Office on Feb. 4, 2022, the entire contents of which are incorporated herein by reference.

### TECHNICAL FIELD

The present disclosure relates to a DataBase Management System (DBMS), and more particularly, to a method of managing meta information in a schema level in a DBMS.

### BACKGROUND ART

Corporate business is rapidly expanding due to the explosive increase of data and the emergence of various environments and platforms. With an advent of a new business environment, more efficient and flexible data services, information processing, and data management functions are required. In line with these changes, research on databases to solve the problems of high performance, high availability, and scalability, which are the basis of enterprise business implementation, is continuing.

Database technology assumes that data is dependent on a particular database. This assumption may make it difficult to achieve good effects when multiple databases use the same data in a distributed database environment. In order for multiple databases to use the same data in a distributed database environment, a method of replicating data and physically storing the data in each database, and a method of using DBLink to make a request to another database each time may be considered. In the method of replicating data and physically storing the data in each database, unnecessary data is duplicated and synchronization between databases is required. In the method of using DBlink, it is necessary to make a work request to the database possessing specific data when the specific data is desired to be processed, so additional load related to the work request may occur.

US Patent Application Publication No. 2021-0089550 presents the method of providing virtualization in the storage unit.

### SUMMARY OF THE INVENTION

The present disclosure has been conceived in response to the foregoing background art, and has been made in an effort to implement database virtualization in a schema level in order to solve problems of data duplication and synchronization in a distributed database environment.

An exemplary embodiment of the present disclosure discloses a method of configuring a virtual database performed by a computing device. The method may include: generating a plurality of schemas by mapping a meta table space including meta information for a schema to the schema, in which one of the plurality of schemas is mapped with one meta table space; and generating a plurality of virtual databases based on at least one schema among the plurality of generated schemas.

In the exemplary embodiment, the plurality of virtual databases may be generated in a schema level.

In the exemplary embodiment, the plurality of schemas may be configured before the plurality of virtual databases is generated.

In the exemplary embodiment, one virtual database among the plurality of virtual databases may include at least one schema. In the exemplary embodiment, a first schema among the plurality of schemas may be shared in the first virtual database and a second virtual database among the plurality of virtual databases.

In the exemplary embodiment, the meta information for the schema may include meta information of an object belonging to the schema and meta information of a table space in which the object is stored.

In the exemplary embodiment, the meta information of the object may include identification information of a table and attribute information of a table. In the exemplary embodiment, the meta information of the table space may include identification information of a table space in which a table is stored.

In the exemplary embodiment, the meta information for the schema may further include information within a schema that does not belong to a specific table space, and dependency information between objects.

In the exemplary embodiment, the meta information for the schema may be managed by the meta table space mapped with the schema.

In the exemplary embodiment, each of the plurality of schemas may refer to data included in the plurality of table spaces based on meta information managed in the mapped meta table space.

In the exemplary embodiment, the method may further include when a query written based on a Structure Query Language (SQL) is received, determining a schema managing first data necessary for processing the query by referring to meta information of the schema, and accessing a table space storing the first data based on the determined schema and processing the first data.

Another exemplary embodiment of the present disclosure discloses a a computer readable storage medium including a computer program. When the computer program is executed by the computing device, the computer program causes a computing device to perform a method for configuring a virtual database. The method may include: generating a plurality of schemas by mapping a meta table space including meta information for a schema to the schema, in which one of the plurality of schemas is mapped with one meta table space; and generating a plurality of virtual databases based on at least one schema among the plurality of generated schemas.

Still another exemplary embodiment of the present disclosure discloses a computing device. The computing device may include: at least one processor; and a storage unit. At least one processor may generate a plurality of schemas by mapping a meta table space including meta information for a schema to the schema, in which one of the plurality of schemas is mapped with one meta table space, and generate a plurality of virtual databases based on at least one schema among the plurality of generated schemas.

The method according to the exemplary embodiment of the present disclosure may solve the problems of data redundancy and synchronization in a distributed database environment.

### BRIEF DESCRIPTION OF THE DRAWINGS

FIG. 1 is a schematic block diagram illustrating a computing device according to an exemplary embodiment of the present disclosure.

FIG. 2 is a flowchart illustrating an example of configuring a virtual database according to an exemplary embodiment of the present disclosure.

FIG. 3 is a conceptual diagram illustrating management of meta information in a schema level according to an exemplary embodiment of the present disclosure.

FIG. 4 is a schematic diagram illustrating a computing environment according to an exemplary embodiment of the present disclosure.

### DETAILED DESCRIPTION

Various exemplary embodiments are described with reference to the drawings. In the present specification, various descriptions are presented for understanding the present disclosure. Prior to describing the specific content for carrying out the present disclosure, it should be noted that the configurations that are not directly related to the technical gist of the present disclosure are omitted within the scope of not disturbing the technical gist of the present disclosure. Further, the terms or words used in the present specification and the claims should be interpreted to have meanings and concepts consistent with the technical spirit of the present disclosure based on the principle that the inventor can define the concept of an appropriate term to best describe the invention.

Terms, “component”, “module”, “system”, “˜unit”, and the like used in the present specification indicate a computer-related entity, hardware, firmware, software, a combination of software and hardware, or execution of software, and may be interchangeably used. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or” not exclusive “or”. That is, unless otherwise specified or when it is unclear in context, “X uses A or B” intends to mean one of the natural comprehensive substitutions. That is, when X uses A, X uses B, or X uses both A and B, or “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical constituent elements, blocks, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, terms expressed as an N^{th}, such as a first, a second, or a third, are used to distinguish at least one entity. For example, the entities represented by a first and a second may be the same as or different from each other.

A schema may mean describing the overall specification of a structure and constraints of a database. For example, the schema may include attributes indicating characteristics of a specific object, an object consisting of a set of attributes, and a definition of a relation existing between the objects. As a further example, a schema may contain constraints that must be maintained between objects. In the present disclosure, information related to the schema is expressed as meta information.

In the database technology in the related art, the schema is set as the database unit, so that one database is configured to include one (concept) schema. Accordingly, the schema generated in the unit of the database is stored and managed in a Data Dictionary (DD).

In the technique according to an embodiment of the present disclosure, the schema(s) for the database are not stored in the DD, but are stored in a meta table space that is mapped with each schema, so various technical effects may be achieved.

For example, in the existing method, meta information of data is centralized and stored in a database, but the method according to an exemplary embodiment of the present disclosure divides meta information of data in a schema level and stores the divided meta information, so that it is possible to manage the meta information in the schema level, and thus one schema may be easily used in various databases. Further, in the technique according to the exemplary embodiment of the present disclosure, the database does not manage meta information related to a schema, so that it is possible to remove the schema dependency for the database. Further, the technique according to the exemplary embodiment of the present disclosure may combine and configure the previously generated schemas when a database is generated, and a schema may be added as necessary, so that it is possible to solve the problems of data duplication and synchronization in a distributed database environment.

In the present disclosure, the meta table space may mean a space or a data structure for storing meta information for a specific schema. For example, the meta table space may be mapped one-to-one with one schema. For another example, depending on the implementation aspect, the case where one schema is mapped with a plurality of meta table spaces may also be considered.

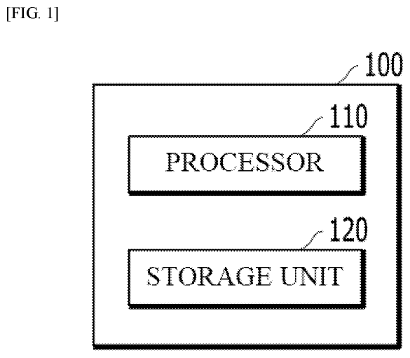

FIG. 1 is a schematic block diagram illustrating a computing device 100 according to an exemplary embodiment of the present disclosure.

The computing device 100 according to the exemplary embodiment of the present disclosure may include a processor 110 and a storage unit 120.

The configuration of a computing device 100 illustrated in FIG. 1 is merely a simplified example. In the exemplary embodiment of the present disclosure, the computing device 100 may include other configurations for performing a computing environment of the computing device 100, and only some of the disclosed configurations may also configure the computing device 100.

In the present disclosure, the computing device 100 may mean a node configuring a system for implementing exemplary embodiments of the present disclosure. The computing device 100 may mean a predetermined type of client or a predetermined type of server. The foregoing components of the computing device 100 are illustrative, and some may be excluded or additional components may be included. For example, when the computing device 100 includes a client, an output unit (not illustrated) and an input unit (not illustrated) may be included within the range.

For example, the client may mean a node(s) in a database system having a mechanism for communication through a network. For example, the client may include a Personal Computer (PC), a laptop computer, a workstation, a terminal, and/or a predetermined electronic device having network accessibility. Further, the client may include a predetermined server implemented by at least one of an agent, an Application Programming Interface (API), and plug-in. For example, the client may be related to a user using the computing device 100 for performing database management. In the foregoing example, the client may issue various forms of queries including a Data Manipulation Language (DML), a Data Definition Language (DDL), and the like to the computing device 100.

In the exemplary embodiment, for example, the computing device 100 may include a predetermined type of computer system or computer device, such as a microprocessor, a mainframe computer, a digital single processor, a portable device, and a device controller. For example, the computing device 100 according to the exemplary embodiment of the present disclosure may include a database server. The computing device 100 may include a Database Management System (DBMS) and a persistent storage. FIG. 1 illustrates one computing device 100 as an example, but it will be apparent to those skilled in the art that more computing devices may also be included in the scope of the present disclosure.

The computing device 100 may include one or more processors 110 and a storage unit 120. In the exemplary embodiment, the storage unit 120 may include a persistent storage medium. In the exemplary embodiment, the storage unit 120 may include one or more memories including a buffer cache. In the exemplary embodiment, the DBMS may be operated by the processor 110 in the memory.

Herein, the memory is a main storage device which a processor directly accesses, such as a RAM including a DRAM and a SRAM, and may mean a volatile storage device in which stored information is instantly erased when a power supply is turned off, but is not limited thereto. The memory may be operated by the processor 110. Otherwise, the memory may also store a data table and/or an index table including a data value. The data table and the index table may include a data value, and in the exemplary embodiment of the present disclosure, the data values of the tables may be recorded in the persistent storage medium from the memory. In an additional aspect, the memory may include a buffer cache, and data may be stored in a data block of the buffer cache. The data may be recorded in the persistent storage medium by a background process.

The persistent storage medium means a non-volatile storage medium, which is capable of continuously storing predetermined data, such as a storage device based on a flash memory and/or a battery-backup memory, as well as a magnetic disk, an optical disk, and a magneto-optical storage device. The persistent storage medium may communicate with the processor 110 and the memory of the computing device 100 through various communication means. In an additional exemplary embodiment, the persistent storage medium may be located outside the computing device 100 and also communicate with the computing device 100. According to the exemplary embodiment of the present disclosure, the persistent storage medium and the memory may be collectively referred to as the storage unit 120.

The DBMS is a program for allowing the computing device 100 to perform any type of operations of the database, such as retrieving, inserting, modifying, and/or deleting necessary data, and creating an index and accessing the index, and as described above, the DBMS may be implemented by the processor 110 in the memory of the computing device 100.

The computing device 100 may transceive data with other computing devices (for example, a client or a database management server) through a communication unit (not illustrated). The communication unit according to the exemplary embodiment of the present disclosure may use a predetermined form of network. The network may include any type of local area or wide area network, or any type of wired or wireless network. The communication unit in the present disclosure may be configured regardless of its communication mode, such as a wired mode and a wireless mode, and may be configured of various communication networks, such as a Personal Area Network (PAN) and a Wide Area Network (WAN). Further, the communication unit may be operated based on the publicly known World Wide Web (WWW), and may also use a wireless transmission technology used in PAN, such as Infrared Data Association (IrDA) or Bluetooth.

In the exemplary embodiment, the processor 110 may consist of one or more cores, and may include a processor, such as a Central Processing Unit (CPU), a General Purpose Graphics Processing Unit (GPGPU), and a Tensor Processing Unit (TPU) of the computing device 100, for analyzing and/or processing data.

According to the exemplary embodiment of the present disclosure, the storage unit 120 may store a predetermined type of information generated or determined by the processor 110 and a predetermined type of information received by the computing device 100. According to the exemplary embodiment of the present disclosure, the storage unit 120 may be a storage medium storing computer software that allows the processor 110 to perform operations according to the exemplary embodiment of the present disclosure. Therefore, the storage unit 120 may also mean computer readable media for storing software codes required for performing the exemplary embodiments of the present disclosure, data that is the execution target of the code, and a result of the code execution.

According to the exemplary embodiment of the present disclosure, the storage unit 120 may also include a web storage performing a storage function on the Internet.

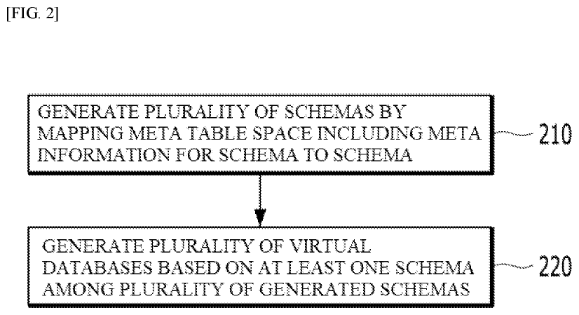

FIG. 2 is a flowchart illustrating an example of configuring a virtual database according to an exemplary embodiment of the present disclosure.

Operations illustrated in FIG. 2 may be performed by the computing device 100. Operations illustrated in FIG. 2 are exemplary operations, and additional operations may be included or some of the operations of FIG. 2 may be excluded or replaced with other operations.

According to the exemplary embodiment of the present disclosure, the computing device 100 may manage meta information in a schema level, not the unit of a database, so that data is not dependent only on a specific database. The computing device 100 may generate a schema so that meta information is managed in a schema level. In the exemplary embodiment, the computing device 100 may generate a plurality of schemas by mapping a meta table space including meta information for the schema to the schema (210).

For example, the meta table space may mean a data structure for storing meta information for a schema. For example, the meta table space may correspond one to one to the schema. According to the exemplary embodiment of the present disclosure, since the meta information related to the schema is managed in the meta table space, the method of the present disclosure may be differentiated from the existing method of managing a schema through a Data Dictionary (DD) for each database.

According to the exemplary embodiment of the present disclosure, the meta information for the schema may include meta information of an object belonging to the schema and meta information of a table space in which the object is stored.

In the present disclosure, the object may mean data structure for storing, processing, and utilizing data. For example, the object may include a table that is a storage space with a row and column structure that actually contains data, an index for rapidly searching for data stored in the table, a view corresponding to an object in which a SELECT statement is stored, a sequence corresponding to an object for managing sequentially increasing numbers, and the like.

In the exemplary embodiment, meta information of the object may include identification information of the table and attribute information of the table. For example, the identification information of the table may include information indicating a name of the table. In the exemplary embodiment, the meta information of the table space may include identification information of the table space in which the table is stored.

The table space in the present disclosure may mean a space in which data within a database object is stored. For example, the table space may correspond to a physical part of the database. For example, the table space may mean a logical data storage structure consisting of one or more data files.

In the exemplary embodiment, the meta information for the schema may further include information within the schema that does not belong to the specific table space, and dependency information between the objects. In the exemplary embodiment, the meta information for the schema may be managed by the meta table space mapped with the schema.

According to the exemplary embodiment of the present disclosure, independent meta information in the schema level may be configured so that data does not depend only on a specific database. For example, the schema may have a one-to-one corresponding meta table space. That is, the schema may include a meta table space for storing meta information for objects belonging to the schema and information about the belonging table space. As described above, the configuration of the meta information in the schema level may allow the schema to be first configured before the configuration of the database, not the standardized method of configuring the database first and configuration a schema later in the existing method.

According to the exemplary embodiment of the present disclosure, the computing device 100 may generate a plurality of databases based on at least one schema among the plurality of generated schemas (220). In the exemplary embodiment, the plurality of databases may mean a plurality of virtual databases.

In the exemplary embodiment, the plurality of virtual databases may be generated in the schema level. The plurality of schemas is generated before the plurality of virtual databases is generated, so that the plurality of virtual databases may be configured in the schema level.

In the exemplary embodiment, the plurality of virtual databases may include one or more schemas. For example, a first virtual database among the plurality of virtual databases may include a first schema and a second schema. Further, a second virtual database among the plurality of virtual databases may include a first schema. In the foregoing example, the first schema among the plurality of schemas may be shared in the first virtual database and the second virtual database among the plurality of virtual databases.

The method according to the exemplary embodiment of the present disclosure may configure a database in a virtualized form by first configuring a schema and then synthesizing related schemas according to the purpose of use. Since the method according to the exemplary embodiment of the present disclosure uses the existing schema without a need to newly generate a separate schema when a virtual database is configured, it is possible to recycle the schema and thus the same schema may be shared in the plurality of virtual databases at the same time. Therefore, the method according to the exemplary embodiment of the present disclosure may freely configure multiple virtual databases by configuring schemas and combining the schemas in a distributed database environment. Accordingly, in order for each virtual database to use the same data in the table space, the schema may be shared in various virtual databases without the need to store the data redundantly, thereby achieving the technical effect that it is possible to efficiently manage data.

In an additional exemplary embodiment of the present disclosure, the computing device 100 may also use a separate management system for storing or managing all global meta information related to all schemas and databases.

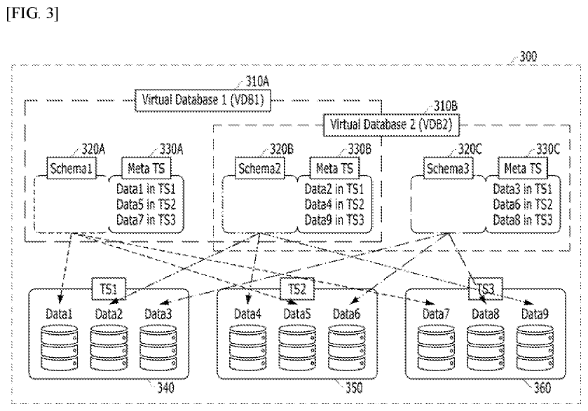

FIG. 3 is a conceptual diagram illustrating management of meta information in a schema level according to an exemplary embodiment of the present disclosure.

FIG. 3 illustrates an example of a virtual database system 300 consisting of virtual databases 310A and 310B. The virtual databases 310A and 310B may be configured and executed by the computing device 100. The computing device 100 may also mean a combination of a plurality of entities, as well as one entity.

According to the exemplary embodiment of the present disclosure, the virtual database may be operated as a single database by linking homogeneous or heterogeneous data scattered across various systems and application programs with each other. For example, the plurality of virtual databases may present a result value corresponding to a single query by executing several subqueries in response to the single query.

As illustrated in FIG. 3, according to the exemplary embodiment of the present disclosure, a first virtual database 310A may be configured to include a first schema 320A and a first meta table space 330A corresponding to the first schema 320A. The first virtual database 310A may be configured to further include a second schema 320B and a second meta table space 330B corresponding to the second schema 320B. As illustrated in FIG. 3, since the method according to the exemplary embodiment of the present disclosure generates virtual databases by first configuring schemas and then combining the configured schemas, the present disclosure may be implemented so that one database includes two or more schemas. The method according to the exemplary embodiment of the present disclosure may generate a plurality of schemas by mapping the meta table space including meta information for the schema and the schema. As described above, the method according to the exemplary embodiment of the present disclosure may map the meta table space and the schema by newly creating the concept of the meta table space for configuring the virtual databases in the schema level, without managing a specific schema to be dependently included in a specific database. Accordingly, the need for a data dictionary (DD) that must exist in correspondence with the database is eliminated, and there is an advantage that a virtual database may be generated according to user needs in the schema level according to the implementation aspect of the database.

As illustrated in FIG. 3, a second virtual database 310B may include a second schema 320B and a third schema 320C. That is, the second virtual database 310B may be generated based on the second schema 320B and the third schema 320C. The second virtual database 310B may include a second meta table space 330B corresponding to the second schema 320B and a third meta table space 330C corresponding to the third schema 320C. As described above, the plurality of virtual databases 310A and 310B may be generated in the schema level. Further, since one schema 320B may be shared by the plurality of virtual databases 310A and 310B, it is possible to manage data more user-friendly and freely without redundant storage of data in a distributed DB environment in which the plurality of virtual databases exists. Further, since the method according to the exemplary embodiment of the present disclosure is capable of utilizing the previously configured schema without the need to generate a separate schema even when a new virtual database is generated, it is possible to freely generate and manage the virtual databases.

According to the exemplary embodiment of the present disclosure, the meta table spaces 330A, 330B, and 330C for the schemas 320A, 320B, and 320C may include meta information corresponding to the schemas. The meta information corresponding to the schema may include meta information of an object belonging to the schema and meta information of a table space in which the object is stored. As illustrated in FIG. 3, for example, the first meta table space 310A corresponding to the first schema 320A may manage first data stored in the first table space 340, fifth data stored in the second table space 350, and seventh data stored in the third table space 360. For example, the second meta table space 310B corresponding to the second schema 320B may manage second data stored in the first table space 340, fourth data stored in the second table space 350, and ninth data stored in the third table space 360. For example, the third meta table space 310C corresponding to the third schema 330B may manage third data stored in the first table space 340, sixth data stored in the second table space 350, and eighth data stored in the third table space 360.

As described above, the method according to the exemplary embodiment of the present disclosure may manage the meta information in the schema level, not the database level. For example, according to the exemplary embodiment of the present disclosure, since table A belongs to schema A, the data dictionary DD of the database does not manage table A, but the separate meta table space mapped with schema A may manage table A. The meta information that may be managed in the schema level may include information of the object belonging to the schema, information of the table space in which the object belongs, information (for example, view, sequence, and/or PL/SQL subprogram) within a schema that does not belong to a specific table space, and/or dependency information between the objects. Each meta information in the schema level may be stored in the meta table space mapped to each schema.

Accordingly, when the meta information is managed in the schema level, it is easy to use one schema in various databases and the database does not manage the meta information for the schema any longer, so that there is an advantage in that it is possible to eliminate dependency between the schema and the database.

In the exemplary embodiment, the meta information for the object may include identification information and attribute information of a table or an index, and the meta information of the table space may include a predetermined type of information for identifying the table space in which the table is stored. Therefore, since it is possible to manage which data is in which table space in the meta table space corresponding to each of the plurality of schemas, the method according to the exemplary embodiment of the present disclosure in which the virtual databases is configured in the schema level may easily manage data scattered in the table spaces.

As illustrated in FIG. 3, each of the plurality of schemas 320A, 320B, and 320C may refer to the data included in the plurality of table spaces based on the meta information managed in the mapped meta table space. For example, when the computing device 100 or the virtual database system 300 in FIG. 3 receives a query written based on a Structured Query Language (SQL), the virtual database system 300 may determine a schema that manages the data necessary for processing the query by referring to the meta information of the schemas 320A, 320B, and 320C. The computing device 100 or the virtual database system 300 in FIG. 3 may process the data by accessing the table space in which the data is stored based on the determined schema.

For example, a query written by a user terminal may be issued in the state where the user terminal first accesses a specific virtual database. When the computing device 100 processes an SQL statement corresponding to the issued query, the computing device 100 may check a schema and a meta table space within the virtual database to which the user terminal accesses. When it is determined that the data necessary for processing the SQL statement is managed in the corresponding schema, the computing device 100 may access the specific data of the corresponding table space by referring to the meta table space. When it is determined that the data necessary for processing the SQL statement is not managed in the corresponding schema, the computing device 100 may make a request for the corresponding data to another virtual database and receive the necessary data, or access the necessary data through another virtual database.

As described above, the method according to the exemplary embodiment of the present disclosure generates a database in the schema level, so that it is possible to generate a virtual database corresponding to each database and then share corresponding data in a distributed database environment. Accordingly, it is possible to solve the existing problems of data redundancy and synchronization, and achieve the technical effect that it is easy to manage data. In addition, in the method according to the exemplary embodiment of the present disclosure, the plurality of databases is capable of sharing the schema, it is possible to solve the problems of data redundancy or overload in a distributed database environment.

For example, the sharing of the same schema by the plurality of virtual databases may include the case where the plurality of virtual databases shares the same physical storage place. Accordingly, when a modification is generated in one database, it is possible to achieve the technical effect in that it is possible to check the contents of the generated modification without a separate data replication or synchronization process in another database.

In the method according to the exemplary embodiment of the present disclosure, the databases are managed in the schema level, it is possible to add a new schema, and it is possible to utilize the existing schemas when a new database is generated, so that it is possible to achieve a distributed DB management with maximized degree of freedom of users and user convenience.

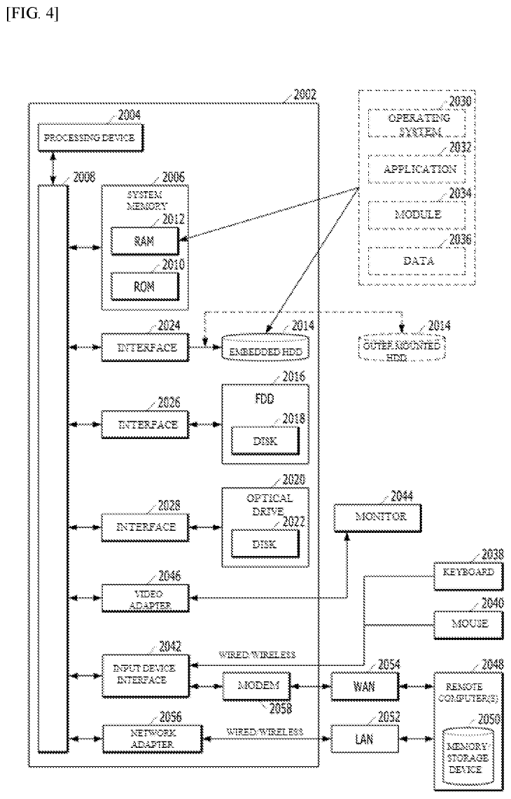

FIG. 4 is a schematic diagram illustrating a computing environment according to an exemplary embodiment of the present disclosure.

In the present disclosure, a component, a module, or a unit includes a routine, a procedure, a program, a component, a data structure, and the like for performing a specific task or implementing a specific abstract data type. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer device generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium.

The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

By way of example, not limitation, the computer 2002 in FIG. 4 may be interchangeably used with the computing device 100.

An illustrative environment 2000 including a computer 2002 and implementing several aspects of the present disclosure is illustrated, and the computer 2002 includes a processing device 2004, a system memory 2006, and a system bus 2008. The system bus 2008 connects system components including the system memory 2006 (not limited) to the processing device 2004. The processing device 2004 may be a predetermined processor among various commonly used processors. A dual processor and other multi-processor architectures may also be used as the processing device 2004.

The system bus 2008 may be a predetermined one among several types of bus structure, which may be additionally connectable to a local bus using a predetermined one among a memory bus, a peripheral device bus, and various common bus architectures. The system memory 2006 includes a ROM 2010, and a RAM 2012. A basic input/output system (BIOS) is stored in a non-volatile memory 2010, such as a ROM, an erasable and programmable ROM (EPROM), and an EEPROM, and the BIOS includes a basic routine helping a transport of information among the constituent elements within the computer 2002 at a time, such as starting. The RAM 2012 may also include a high-rate RAM, such as a static RAM, for caching data.

The computer 2002 also includes an embedded hard disk drive (HDD) 2014 (for example, enhanced integrated drive electronics (EIDE) and serial advanced technology attachment (SATA)), a magnetic floppy disk drive (FDD) 2016 (for example, which is for reading data from a portable diskette 2018 or recording data in the portable diskette 2018), and an SSD and an optical disk drive 2020 (for example, which is for reading a CD-ROM disk 2022, or reading data from other high-capacity optical media, such as a DVD, or recording data in the high-capacity optical media). A hard disk drive 2014, a magnetic disk drive 2016, and an optical disk drive 2020 may be connected to the system bus 2008 by a hard disk drive interface 2024, a magnetic disk drive interface 2026, and an optical drive interface 2028, respectively. An interface 2024 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 2002, the drive and the medium correspond to the storage of random data in an appropriate digital form. In the description of the computer readable storage media, the HDD, the portable magnetic disk, and the portable optical media, such as a CD, or a DVD, are mentioned, but those skilled in the art will well appreciate that other types of computer readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 2030, one or more application programs 2032, other program modules 2034, and program data 2036 may be stored in the drive and the RAM 2012. An entirety or a part of the operation system, the application, the module, and/or data may also be cached in the RAM 2012. It will be appreciated that the present disclosure may be implemented in a variety of commercially available operating systems or combinations of operating systems.

A user may input a command and information to the computer 2002 through one or more wired/wireless input devices, for example, a keyboard 2038 and a pointing device, such as a mouse 2040. Other input devices (not illustrated) may be a microphone, an IR remote controller, a joystick, a game pad, a stylus pen, a touch screen, and the like. The foregoing and other input devices are frequently connected to the processing device 2004 through an input device interface 2042 connected to the system bus 2008, but may be connected by other interfaces, such as a parallel port, an IEEE 1394 serial port, a game port, a USB port, an IR interface, and other interfaces.

A monitor 2044 or other types of display devices are also connected to the system bus 2008 through an interface, such as a video adaptor 2046. In addition to the monitor 2044, the computer generally includes other peripheral output devices (not illustrated), such as a speaker and a printer.

The computer 2002 may be operated in a networked environment by using a logical connection to one or more remote computers, such as remote computer(s) 2048, through wired and/or wireless communication. The remote computer(s) 2048 may be a work station, a server computer, a router, a personal computer, a portable computer, a microprocessor-based entertainment device, a peer device, and other general network nodes, and generally includes some or an entirety of the constituent elements described for the computer 2002, but only a memory storage device 2050 is illustrated for simplicity. The illustrated logical connection includes a wired/wireless connection to a local area network (LAN) 2052 and/or a larger network, for example, a wide area network (WAN) 2054. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 2002 is used in the LAN networking environment, the computer 2002 is connected to the local network 2052 through a wired and/or wireless communication network interface or an adaptor 2056. The adaptor 2056 may make wired or wireless communication to the LAN 2052 easy, and the LAN 2052 also includes a wireless access point installed therein for the communication with the wireless adaptor 2056. When the computer 2002 is used in the WAN networking environment, the computer 2002 may include a modem 2058, is connected to a communication server on a WAN 2054, or includes other means setting communication through the WAN 2054 via the Internet. The modem 2058, which may be an embedded or outer-mounted and wired or wireless device, is connected to the system bus 2008 through a serial port interface 2042. In the networked environment, the program modules described for the computer 2002 or some of the program modules may be stored in a remote memory/storage device 2050. The illustrated network connection is illustrative, and those skilled in the art will appreciate well that other means setting a communication link between the computers may be used.

The computer 2002 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

What is claimed is:

1. A method of configuring a virtual database performed by a computing device, the method comprising:
generating a plurality of schemas by mapping a meta table space including meta information for a schema to the schema, in which one of the plurality of schemas is mapped with one meta table space; and
generating a plurality of virtual databases based on at least one schema among the plurality of generated schemas.

2. The method of claim 1, wherein the plurality of virtual databases is generated in a schema level.

3. The method of claim 1, wherein the plurality of schemas is configured before the plurality of virtual databases is generated.

4. The method of claim 1, wherein a first virtual database among the plurality of virtual databases includes a first schema and a second schema, and
a first schema among the plurality of schemas is shared in the first virtual database and a second virtual database among the plurality of virtual databases.

5. The method of claim 1, wherein the meta information for the schema includes meta information of an object belonging to the schema and meta information of a table space in which the object is stored.

6. The method of claim 5, wherein the meta information of the object includes identification information of a table and attribute information of a table, and
the meta information of the table space includes identification information of a table space in which a table is stored.

7. The method of claim 5, wherein the meta information for the schema further includes information within a schema that does not belong to a specific table space, and dependency information between objects.

8. The method of claim 1, wherein the meta information for the schema is managed by the meta table space mapped with the schema.

9. The method of claim 1, wherein each of the plurality of schemas refers to data included in the plurality of table spaces based on meta information managed in the mapped meta table space.

10. The method of claim 1, further comprising:
when a query written based on a Structure Query Language (SQL) is received, determining a schema managing first data necessary for processing the query by referring to meta information of the schema, and accessing a table space storing the first data based on the determined schema and processing the first data.

11. A computer readable storage medium including a computer program, the computer program causing a computing device to perform a method for configuring a virtual database when the computer program is executed by the computing device, the method comprising:
generating a plurality of schemas by mapping a meta table space including meta information for a schema to the schema, in which one of the plurality of schemas is mapped with one meta table space; and
generating a plurality of virtual databases based on at least one schema among the plurality of generated schemas.

12. A computing device, comprising:
at least one processor; and
a storage unit,
wherein said at least one processor generates a plurality of schemas by mapping a meta table space including meta information for a schema to the schema, in which one of the plurality of schemas is mapped with one meta table space, and generates a plurality of virtual databases based on at least one schema among the plurality of generated schemas.
